(19) United States
(12) Patent Application Publication
(10) Pub. No.: US 2014/0176507 A1
(43) Pub. Date: Jun. 26, 2014

(54) PIEZO-POWERED SENSOR CARD AND METHOD THEREFOR

(71) Applicant: PALO ALTO RESEARCH CENTER INCORPORATED, Palo Alto, CA (US)

(72) Inventor: Jurgen H. Daniel, Washington, DC (US)

(73) Assignee: PALO ALTO RESEARCH CENTER INCORPORATED, Palo Alto, CA (US)

(21) Appl. No.: 13/723,606

(22) Filed: Dec. 21, 2012

(51) Int. Cl. G06F 3/043

(52) U.S. Cl. CPC G06F 3/043
USPC 345/177

(57) ABSTRACT

An electronic sensor device, powered by a piezoelectric source and including an electronic element, is provided. The device may be used to test for the presence of substance such as a gas, a liquid, a chemical substance or a biological substance, etc. When the device is exposed to the substance, the electronic state (resistance/capacitance) of the electronic element (such as a transistor) changes (e.g. impacts the color of a connected display element) to allow for visual detection of the substance by a user.

### BACKGROUND

Printed electronics enables the integration of electronic, optical and other functionalities into products at potentially ultra-low cost. In order to provide power to electronic circuits, often printed batteries are discussed, but they have several disadvantages. Batteries employ electrolytes which make the fabrication (particular with respect to sealing or encapsulation) relatively complex and, moreover, batteries lose charge over time. Piezoelectric power sources can be fabricated more easily with a smaller form factor, and there is little concern of becoming non-functional because of lost charge.

### BRIEF DESCRIPTION

In one aspect of the presently described embodiments, the device comprises a substrate, a piezoelectric power source on the substrate, a plurality of sensing elements on the substrate connected to the piezoelectric power source, the sensing elements being operative to change electronic state upon detection of a substance, and, a plurality of display elements on the substrate corresponding to the plurality of sensing elements on the substrate, the display elements being operative to display based the electronic state of the corresponding sensing elements when the piezoelectric power source is activated.

In another aspect of the presently described embodiments, the sensing elements are resistive elements and the electronic state is resistance.

In another aspect of the presently described embodiments, the sensing elements are capacitive elements and the electronic state is capacitance.

In another aspect of the presently described embodiments, the sensing elements comprise thin film transistors.

In another aspect of the presently described embodiments, the sensing elements comprise chemical field effect transistors.

In another aspect of the presently described embodiments, the sensing elements have diffusion barriers of varying thickness.

In another aspect of the presently described embodiments, the display elements comprise at least one of reflective display elements, emissive display elements, electrophoretic display elements, electrochromic display elements, MEMS display elements, Gyricon display elements, powder display elements, liquid crystal display elements, electrowetting display elements, electrochemical display elements, electroluminescent display elements, or OLED display elements.

In another aspect of the presently described embodiments, the display elements are voltage-driven display elements.

In another aspect of the presently described embodiments, the display elements are current driven display elements.

In another aspect of the presently described embodiments, the substrate is formed of at least one of a plastic or polymer material, paper, thin flexible metal, thin flexible glass or ceramic material.

In another aspect of the presently described embodiments, the piezoelectric power source is formed of a polymeric piezoelectric material, piezo-composite material, ferro-electric material or inorganic piezo materials.

In another aspect of the presently described embodiments, the method comprises removing a protective sheet from a sensor device, exposing sensor areas of the sensor device to the substance to initiate a reaction between sensing elements in the sensor areas and the substance to change a state of the sensing elements, agitating a piezoelectric power source on the sensor device, and, changing a display on the device based on the change of the state of the sensing elements, the display being powered by the piezoelectric power source.

In another aspect of the presently described embodiments, the sensing elements comprise resistive elements.

In another aspect of the presently described embodiments, the sensing elements comprise capacitive elements.

In another aspect of the presently described embodiments, the display comprises display elements.

In another aspect of the presently described embodiments, the agitating comprises at least one of bending, pushing or shaking the piezoelectric power source.

In another aspect of the presently described embodiments, the changing of the display comprises changing a color of a display element.

In another aspect of the presently described embodiments, the changing of the display comprises changing a timeline on the sensor device.

### BRIEF DESCRIPTION OF THE DRAWINGS

FIGS. 1(a) and (b) show a representative view of an example device according to the presently described embodiments;

FIG. 2 is a flow chart illustrating a method according to the presently described embodiments; and,

FIG. 3 is a representative view of another example device according to the presently described embodiments.

### DETAILED DESCRIPTION

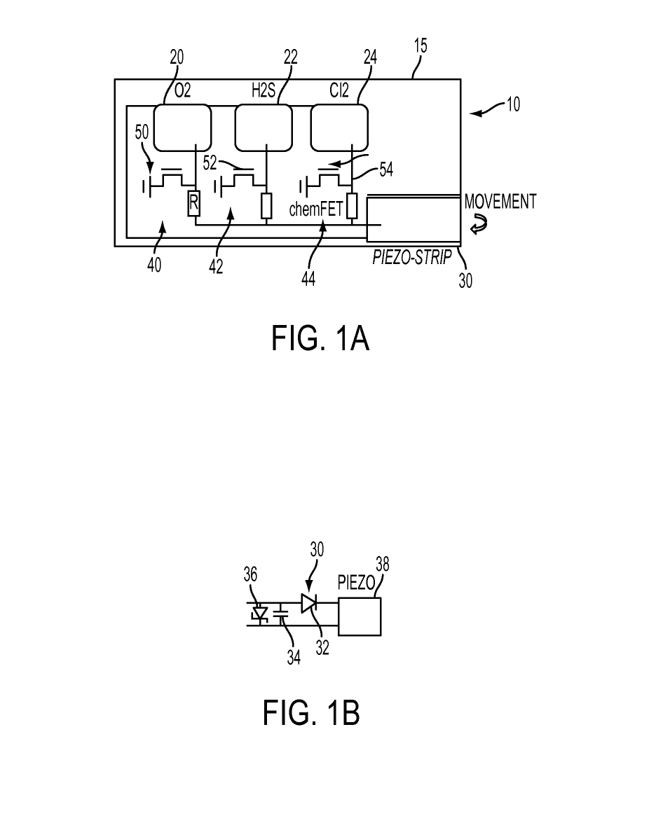

The presently described embodiments relate to, in one form, an electronic sensor device or card which is powered by a piezoelectric source (such as a strip or foil), and includes an electronic sensing element and a display element. The elements of the card, in at least some forms, are printed on the device or card. The card or device may be used to test for the presence of a substance such as a gas, a liquid, a chemical substance or a biological substance, . . . etc. For example, as will be discussed hereafter in connection with FIG. 1(a), the device may detect the presence of oxygen, hydrogen sulfide or chlorine gas. In this regard, in one form, when the device is exposed to the substance, the electronic state (e.g. resistance or capacitance) of the electronic sensing element (such as a transistor) changes (e.g. impacts the color of the connected display element) to allow for visual detection of the substance by a user.

With more particular reference to FIG. 1(a), a device 10 is illustrated. The device 10 includes a substrate 15 and display elements 20, 22, and 24. The substrate may take a variety of forms including a card or card-sized device formed of plastic or polymer material, paper, thin flexible metal or thin flexible glass, ceramic or other substrate material. The display elements 20, 22, and 24 are connected to a power source 30, such as a piezoelectric power source, via sensing elements such as electronic or resistive elements 40, 42, and 44. With respect to these elements, at least part of their electronic state (e.g. resistance or capacitance) changes upon reaction with a substance. Accordingly, these elements act as sensors and define sensor areas on the device. In this regard, in one form, the electronic or resistive elements comprise thin film transistors (TFTs) 50, 52 and 54 configured as chemical Field effect transistors (chemFets). Each display element 20, 22, and 24 is connected to a corresponding electronic or resistive element 40, 42 and 44. ChemFets have a functionalized gate electrode (or a gate region that is sensitive to chemical reactions) and reaction with a chemical substance will change the gate potential. As shown as a mere example, the transistors 50, 52 and 54 are reactive to oxygen, hydrogen sulfide and chlorine gas, respectively; however, a variety of chemical substances may be detected using alternative elements and/or with appropriate changes to the system. This reaction, in turn, will change the trans-conductance of the TFT, and thus change the voltage that is applied to the corresponding display element when the power source is activated. In one form, if the change turns the TFT less conductive, a higher voltage is experienced by the corresponding display element. In these forms, the display elements are voltage-driven display elements. Accordingly, the appearance of the display is changed. In at least one form, a color of the display element is changed to indicate the detection or sensing of the substance. Current driven display elements may also be employed in which case the transistor and the display element may be connected in series.

The display elements 20, 22, and 24 are powered by the charge of the piezoelectric element 30. The display elements 20, 22, and 24 may take a variety of forms. However, some examples of display elements include reflective and emissive display elements such as electrophoretic display elements, electrochromic display elements, MEMS (Micro Electro Mechanical System) display elements, Gyricon display elements, powder display elements, liquid crystal display elements, electrowetting display elements, electrochemical display elements, electroluminescent display elements, OLED (organic light emitting diode) display elements and display elements using other suitable display technologies.

As noted above, a battery source is generally too sophisticated for a device according to at least some of the presently described embodiments because the readout of the sensor only takes a short time. Accordingly, in at least some forms, a power source such as the piezoelectric power source 30 is implemented. In this regard, a polymer piezoelectric material such as PVDF (polyvinylidene fluoride) or PVDF-TrFE (polyvinylidene fluoride-Trifloroethylene) copolymer or other known piezoelectric polymer material may be applied to a substrate using printing or lamination methods. The piezoelectric material may include any other material that produces a charge when mechanically stressed. Examples are piezo-composite material, ferro-electret material, and transferred layers of inorganic piezomaterials.

In this regard, FIG. 1(b) shows an example of a piezoelectric power source 30 with rectifying diode 32, storage capacitor 34, zener diode 36 and piezoelectric material 38. All, or a subset, of these elements may be used in the piezoelectric power supply circuit. Likewise, all, or part, of the elements described may be printed using known printing technologies. Also, various circuit configurations may be implemented.

Referring back to FIG. 1(a), the electronic or resistive elements 40, 42 and 44 may take a variety of different forms. In at least one form, as noted above, these elements include chemFETs 50, 52 and 54—which may also take a variety of forms. Such chemFets may be based on a variety of platforms including an organic semiconductor material (e.g. P3HT (poly-3-hexylthiophene), PQT12 (a polythiophene) or carbon nanotubes). Inorganic semiconductors, such as amorphous silicon or transparent oxide semiconductor devices, may also be applied.

The electronic or resistive structure illustrated is merely an example. In this regard, a resistance change may occur by other means—such as simple degradation of an organic semiconductor. The semiconductor may be part of a simple resistive structure or it may be part of a TFT. Further, it is contemplated that circuits for current-driven display elements could also be implemented wherein a chemical reaction changes the resistance of an electronic element—which in turn modulates the current to the display element. Still further, instead of resistive components, capacitive components (in which the capacitance changes when reacted with a chemical substance) may be employed.

The sensor device or card 10 may be fabricated in a variety of manners. However, in at least one form, as noted above, this device is fabricated using inexpensive fabrication methods such as printing. In this regard, the electronic circuits as well as other components may be printed on the substrate. This is a factor in many implementations where the resultant device or card will likely be low-cost and disposable. Further, it should be appreciated that protective films or sheets (not shown) may be applied to a card or device to protect or isolate elements until such time as the card or device is used. The film or sheet may cover all, or part, of the card or device.

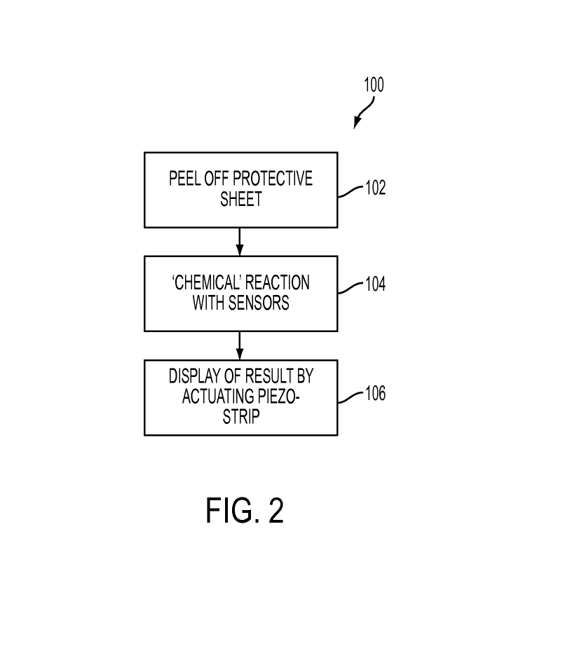

In operation, the card or device 10 according to the presently described embodiments may be manipulated in a variety of manners. For example, FIG. 2 illustrates an example method 100 according to the presently described embodiments. In this regard, as noted, a sensor card or device may carry a protective sheet that isolates the sensors or sensor areas (e.g. the electronic or resistive elements described above) from the environment (e.g. air). As shown in FIG. 2, the protective sheet is removed or peeled off at the start of the test to expose the sensors or sensor areas to the chemicals (e.g. gases in the air) (at 102). If a gas, etc. is present, it will react with the sensors and change their electrical property electronic state (e.g. resistance) (at 104). After some time has passed (test period), the sensor card is read out by agitating the piezoelectric strip (at 106). In this way, the piezoelectric strip may be deflected by bending, pushing or shaking, etc., which generates a charge. The charge is then transferred to the displays through the electronic or resistive elements. The display elements will then provide a display based on the state of the sensor areas.

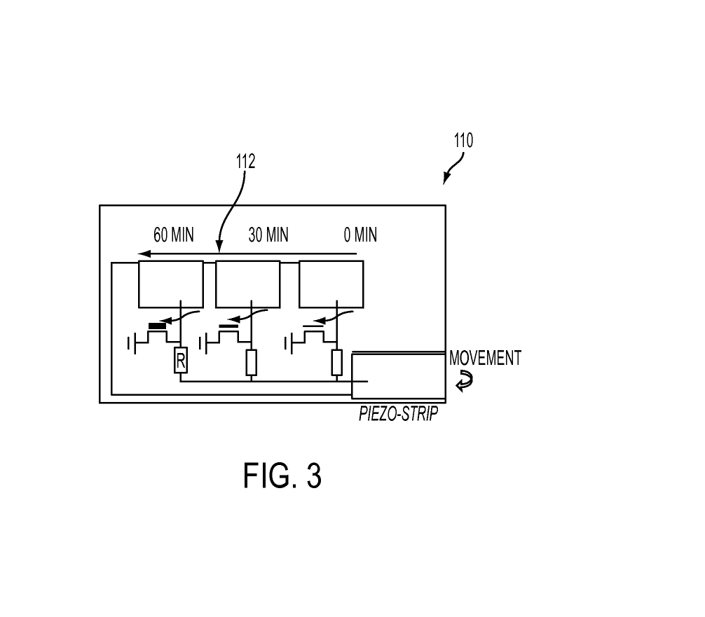

In another embodiment, a sensor device or card 110 accordingly to the presently described embodiments may be also used to determine the time a product has been exposed to a chemical, gas, etc. In this regard, with reference to FIG. 3, an example of a printed card or device 110 shows the length of time the card was exposed to a chemical on timeline 112. In this regard, the TFTs shown may carry a protective coating or diffusion barrier of varying, e.g., increasing, thickness and the diffusion time of the chemical through the protective coating determines the TFT degradation (Vt shift, mobility change). In the example of a moisture sensor, the protective coating may be on top of a layer of calcium (Ca) (similar to the well-known Ca-test) and the degradation of the Ca layer with exposure time modulates the resistivity of the calcium layer. In this case, the resistive element does not need to be a TFT but can be just a simple resistive element.

In other variations, the sensor card or device may be applied (e.g. as a sticker) to a surface. In one such example, the device or card is applied to a tube which is used to suction water. When the water comes in contact with the label surrounding the tube (e.g. through a porous area in the tube where the sticker is attached), ingredients in the water react with the sensors.

Further, although in some applications a battery is not desired, there may be implementations of the present application where a battery may be used instead of a piezoelectric strip. A switch would be used to apply power for readout.

Still further, the card or device described is used in chemical/bio-testing. However, a similar concept may be used to test for pressure (or other properties) applied to the card surface.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A sensor device comprising:
a substrate;
a piezoelectric power source on the substrate;
a plurality of sensing elements on the substrate connected to the piezoelectric power source, the sensing elements being operative to change electronic state upon detection of a substance; and,
a plurality of display elements on the substrate corresponding to the plurality of sensing elements on the substrate, the display elements being operative to display based on the electronic state of the corresponding sensing elements when the piezoelectric power source is activated.

2. The device as set forth in claim 1 wherein the sensing elements are resistive elements and the electronic state is resistance.

3. The device as set forth in claim 1 wherein the sensing elements are capacitive elements and the electronic state is capacitance.

4. The device as set forth in claim 1 wherein the sensing elements comprise thin film transistors.

5. The device as set forth in claim 1 wherein the sensing elements comprise chemical field effect transistors.

6. The device as set forth in claim 1 wherein the sensing elements have diffusion barriers of varying thickness.

7. The device as set forth in claim 1 wherein the display elements comprise at least one of reflective display elements, emissive display elements, electrophoretic display elements, electrochromic display elements, MEMS display elements, Gyricon display elements, powder display elements, liquid crystal display elements, electrowetting display elements, electrochemical display elements, electroluminescent display elements, or OLED display elements.

8. The device as set forth in claim 1 wherein the display elements are voltage-driven display elements.

9. The device as set forth in claim 1 wherein the display elements are current driven display elements.

10. The device as set forth in claim 1 wherein the substrate is formed of at least one of a plastic or polymer material, paper, thin flexible metal, thin flexible glass or ceramic material.

11. The device as set forth in claim 1 wherein the piezoelectric power source is formed of a polymeric piezoelectric material, piezo-composite material, ferro-electric material or inorganic piezo materials.

12. A method for detecting a substance comprising:
removing a protective sheet from a sensor device;
exposing sensor areas of the sensor device to the substance to initiate a reaction between sensing elements in the sensor areas and the substance to change a state of the sensing elements;
agitating a piezoelectric power source on the sensor device; and,
changing a display on the device based on the change of the state of the sensing elements, the display being powered by the piezoelectric power source.

13. The method as set forth in claim 12 wherein the sensing elements comprise resistive elements.

14. The method as set forth in claim 12 wherein the sensing elements comprise capacitive elements.

15. The method as set forth in claim 12 wherein the display comprises display elements.

16. The method as set forth in claim 12 wherein the agitating comprises at least one of bending, pushing or shaking the piezoelectric power source.

17. The method as set forth in claim 12 wherein the changing of the display comprises changing a color of a display element.

18. The method as set forth in claim 12 wherein the changing of the display comprises changing a timeline on the sensor device.
